(19) United States
(12) Patent Application Publication
(10) Pub. No.: US 2011/0007075 A1
(43) Pub. Date: Jan. 13, 2011

(54) DATA PROCESSING APPARATUS AND METHOD

(75) Inventor: Won Kyu LEE, Goyang-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/732,139

(22) Filed: Mar. 25, 2010

(30) Foreign Application Priority Data
Jul. 7, 2009 (KR) 10-2009-0061475

(51) Int. Cl. G06T 11/20; G06F 3/048

(52) U.S. Cl. 345/440; 715/769

(57) ABSTRACT

A data processing apparatus and method are provided. A first pie chart graphic is generated from first node data of a first node among hierarchical data and is displayed on a display. A processor analyzes an input to determine second node data of a second node that is an access target among the hierarchical data. A second pie chart graphic is generated from the second node data.

### CROSS-REFERENCE TO RELATED APPLICATION(S)

This application claims the benefit under 35 U.S.C. §119(a) of Korean Patent Application No. 10-2009-0061475, filed on Jul. 7, 2009, in the Korean Intellectual Property Office, the entire disclosure of which is incorporated herein by reference for all purposes.

### BACKGROUND

1. Field

The following description relates to a data processing apparatus and method, and more particularly, to a data processing apparatus and method for visualization of hierarchical data for each node, and to a data processing apparatus and method for visualization of a hierarchical pie chart.

2. Description of Related Art

A pie chart is one type of graph to visualize statistical matters or schedules, and may generally display data contents. For example, a pie chart may display a ratio of detailed items using pie sectors dividing a circular disk.

Where detailed items are included in data to be visualized using the pie chart and at least one of the detailed items includes its detailed items, the pie chart may be provided in a hierarchical structure.

To visualize a hierarchical pie chart, a method of dividing an edge portion of each of pie sectors included in a disk into a plurality of areas, to visualize data, has been proposed. However, where depths of the hierarchical pie chart increase, labeling may become difficult and a design complexity may increase.

### SUMMARY

In one general aspect, a data processing apparatus includes a storage unit configured to store hierarchical data, a display unit configured to display a first pie chart graphic that is generated from first node data of a first node among the hierarchical data, and a processor configured to analyze a pointing input to determine second node data of a second node that is an access target among the hierarchical data, and to generate a second pie chart graphic from the second node data.

The pointing input may correspond to a touch input.

The first pie chart graphic may include at least one of parent node information of the first node and sibling node information of the first node.

Where the display unit displays the first pie chart graphic, the display unit may display context information associated with the first node and a node of which information is included in the first pie chart graphic.

Where the touch input corresponds to a drag, the processor may analyze a direction of the drag to determine a sibling node of the first node as the second node. Where the touch input does not correspond to the drag, the processor may analyze a touch input point to determine any one of a parent node of the first node and a child node of the first node as the second node. The processor may generate the second pie chart graphic from the determined second node data.

The second pie chart graphic may include at least one of parent node information of the second node and sibling node information of the second node.

The display unit may convert the first pie chart graphic to the second pie chart graphic generated by the processor to display the converted second pie chart graphic.

Where the display unit displays the second pie chart graphic, the display unit may display context information associated with the second node and a node of which information is included in the second pie chart graphic.

Where the pointing input is received in a point corresponding to a third node among the displayed context information, the processor may determine the third node as the second node that is the access target, and generate the second pie chart graphic from the second node data.

The hierarchical data may correspond to schedule data used in a personal schedule management program.

The display unit may display an indicator indicating a current time together with the first pie chart graphic that is generated from the first node data.

The display unit may display context information associated with the first node together with the first pie chart graphic that is generated from the first node data.

The display unit may display a first graphic area, corresponding to a parent node of the first node, around the first pie chart graphic, and where the pointing input corresponds to a drag input starting from the first graphic area, the processor may determine a sibling node of the first node as the second node that is an access target, and generate the second pie chart graphic from the second node data.

The display unit may display a second graphic area, corresponding to a grandparent node of the first node, around the first graphic area, and where the pointing input corresponds to the drag input starting from the second graphic area, the processor may determine any one of child nodes of the sibling node of the grandparent node of the first target as the second node that is the access target, and generate the second pie chart graphic from the second node data.

In another general aspect, a data processing method includes generating a first pie chart graphic from first node data of a first node among hierarchical data to display the first pie chart graphic, analyzing a touch input detected via a touch panel to determine second node data of a second node that is an access target among the hierarchical data, and to access the second node data, and generating a second pie chart graphic from the second node data to display the second pie chart graphic.

The generating and the displaying of the first pie chart graphic may include retrieving a sibling node of the first node by referring to parent node information of the first node, generating the first pie chart graphic by combining child node information of the first node with at least one of parent node information of the first node and sibling node information of the first node, and displaying the first pie chart graphic.

The generating and the displaying of the first pie chart graphic may include displaying context information associated with the first node and at least one node that is generated into the first pie chart graphic and is displayed together with the first node.

The analyzing, the determining, and the accessing may include analyzing a drag direction to determine a sibling node of the first node as the second node, where the detected touch input correspond to a drag input, analyzing a touch input point to determine any one of a parent node of the first node and a child node of the first node, as the second node, and accessing the second node data stored in a database to read the second node data from the database.

The displaying and the generating of the second pie chart graphic may include retrieving a sibling node of the second node by referring to parent node information of the second node, generating the second pie chart graphic by combining child node information of the first node with at least one of parent node information of the second node and sibling node information of the second node, and displaying the second pie chart graphic.

In still another aspect, there is provided a computer-readable recording medium storing a program for implementing a data processing method including generating a first pie chart graphic from first node data of a first node among hierarchical data to display the first pie chart graphic, analyzing a touch input detected via a touch panel to determine second node data of a second node that is an access target among the hierarchical data, and to access the second node data, and generating a second pie chart graphic from the second node data to display the second pie chart graphic.

Other features and aspects will be apparent from the following detailed description, the drawings, and the claims.

### BRIEF DESCRIPTION OF THE DRAWINGS

FIG. 1 is a block diagram illustrating an example of a data processing apparatus.

FIG. 2 is a diagram illustrating an example of a hierarchical data structure.

FIG. 3 is a diagram illustrating an example of node data included in hierarchical data.

FIG. 4 is a diagram illustrating an example of a pie chart graphic.

FIG. 5 is a diagram illustrating another example of a pie chart graphic.

FIG. 6 is a diagram illustrating an example of a pie chart graph used as a schedule program.

FIG. 7 is a diagram illustrating still another example of a pie chart graphic.

FIG. 8 is a flowchart illustrating an example of a data processing method.

FIG. 9 is a flowchart illustrating an example of an operation of accessing a second node of FIG. 8.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

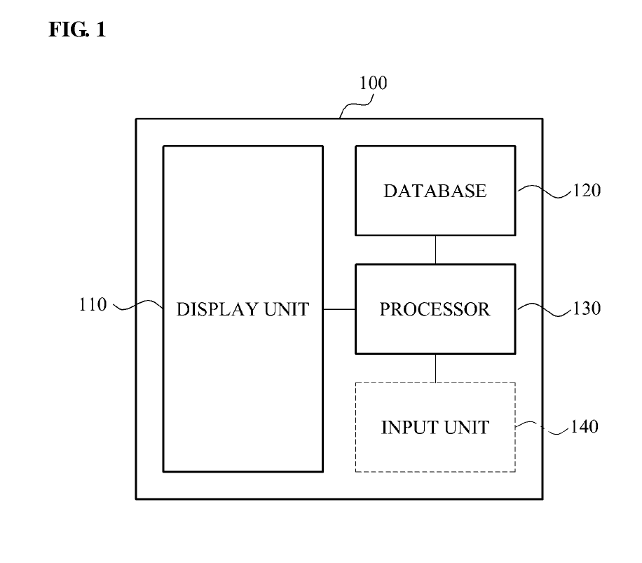

FIG. 1 illustrates an example of a data processing apparatus 100.

A display unit 110 displays a first pie chart graphic with respect to a first node that is a current focusing target.

A processor 130 may access first node data of the first node to read an index and a weight of each of child nodes of the first node.

The processor 130 divides a disk, or pie, by allocating a pie sector of a size corresponding to the weight of each of the child nodes of the first node, and thereby generates a pie chart. The display unit 110 displays the generated pie chart.

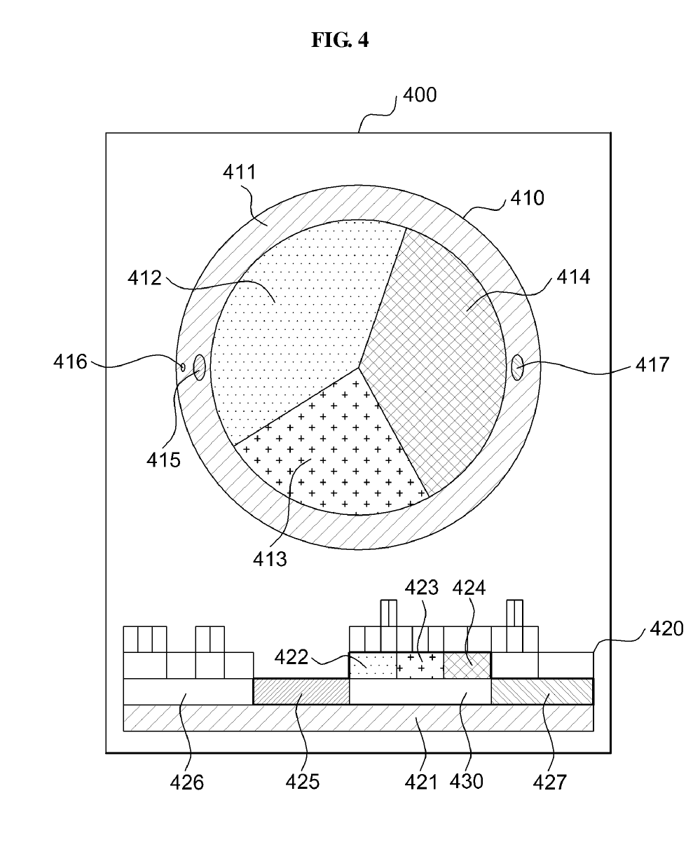

Generating/displaying of a first pie chart graphic, displaying of a map for context information, and the like is further described below with reference to FIG. 4.

An input unit 140 may convert, to an electrical signal, an input signal that is received from an outside source. The input unit 140 may be, for example, a sensor panel of a touch pad and the like, but is not limited thereto. The input unit 140 may also be combined with the display unit 110 and be provided as a touch screen. Where a touch input is received, the processor 130 may analyze the touch input.

It may be determined whether the touch input corresponds to a drag (i.e. a dragging motion, for example). Where the touch input corresponds to the drag, a direction of the drag may be determined. Conversely, where the touch input does not correspond to the drag, a touched point may be determined Depending on the result, a second node that is an access target may be determined.

A process of determining the second node and a process of generating a second pie chart graphic with respect to the second node is described later.

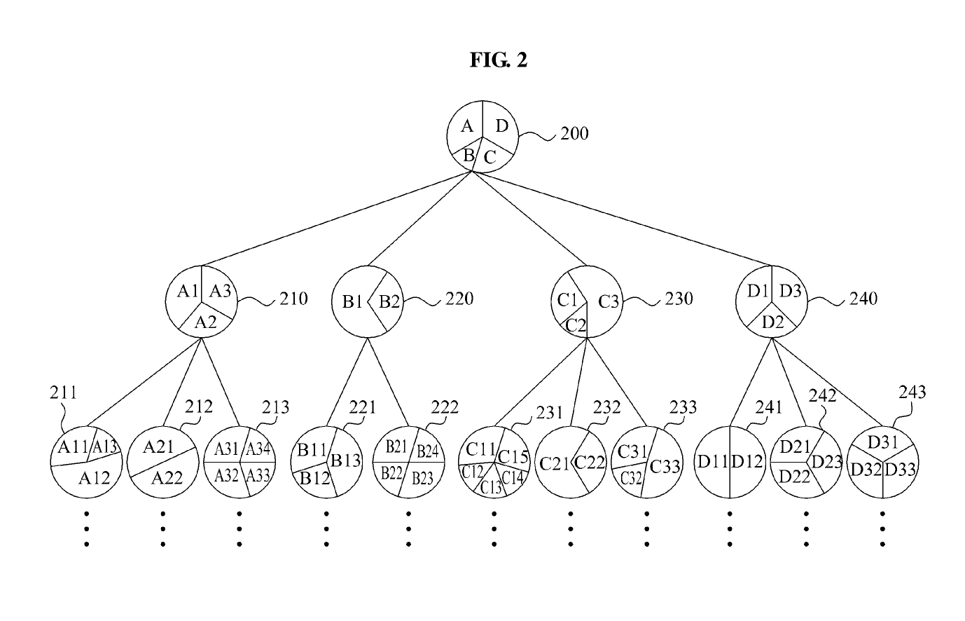

FIG. 2 illustrates an example of hierarchical data structure.

The hierarchical data structure is a tree-like structure. In the tree-like structure, among a plurality of nodes included in a data structure, a single parent node corresponds to n other child nodes. Here, n may denote a non-negative integer.

Hierarchical data may include a single root node 200. In FIG. 2, the root node 200 may include four child nodes 210, 220, 230, and 240.

In the example shown in FIG. 2, the child node 210 includes three grandchild nodes 211, 212, and 213. The child node 220 includes two grandchild nodes 221 and 222. The child node 230 includes three grandchild nodes 231, 232, and 233. The child node 240 includes three grandchild nodes 241, 242, and 243.

As a non-limiting example, the hierarchical data may be a research result regarding statistical data, for example, an approval rating for a political party. The approval rating for the political party may be included in data of the root node 200 as child node information. For example, an approval rating for each of political parties A, B, C, and D may be included in the data of the root node 200.

A ratio of each of age groups of people supporting the political party A may be stored in data of the child node 210 using an age group of 18 to 30 (A1), an age group of 31 to 55 (A2), and an age group of 56 and over (A3).

Residential districts of the age group A3 may be divided into A31, A32, A33, and A34, and a ratio of each of A31, A32, A33, and A34 may be stored in data of the grandchild node 213.

Where the hierarchical data is generated as above, it may be possible to perform focusing and provide context information by generating a pie chart graphic.

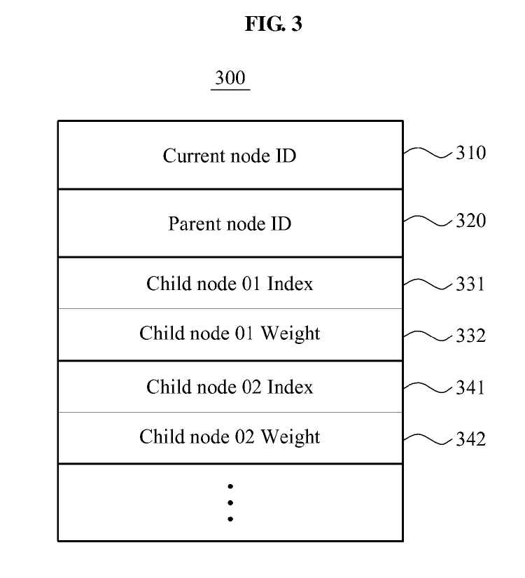

FIG. 3 is a diagram illustrating an example of node data 300 included in hierarchical data.

A node ID 310 of a current node may be included in the data. A parent node ID 320 of the node, indexes of child nodes 331, and relative weights of the child nodes 332, 341, and 342 may be included in the node data 300. Here, the relative weight may be zero or one.

A process of using node data to generate a pie chart graphic is described later.

FIG. 4 illustrates an example of a first pie chart graphic 410.

The first pie chart graphic 410 is included within an image 400 displayed on the display unit 110 of FIG. 1. In this example, a first node included in hierarchical data may include a single parent node and three child nodes.

The first pie chart graphic 410 is generated by the processor 130. The processor 130 may access first node data to read an index and a weight of each of the three child nodes included in the first node.

A pie sector of a size corresponding to the weight of each of the three child nodes may be allocated. In this example, pie sectors 412, 413, and 414 are allocated to the three child nodes.

The pie sector 412 or 414 is relatively larger than the pie sector 413. Accordingly, it may be known that the weight of the child node allocated with the pie sector 413 is relatively smaller than the weight of the child node allocated with the pie sector 412 or the weight of the child node allocated with the pie sector 414.

The processor 130 may generate weight information of the child nodes included in the first node data into a graphic, using a plurality of pie sectors included in a single disk. The above expression type may be referred to as “focusing” with respect to the first node among the plurality of nodes included in the entire hierarchical data including the first node.

The processor 130 may include, in the first pie chart graphic 410, performing focusing with respect to the first node and also information (also referred to as “context information”) regarding a location the first node may be located within the entire hierarchical data. The processor 130 may separately generate and provide an additional graphic.

An example of including context information in the first pie chart graphic 410 is described below.

Information regarding which node corresponds to a parent node of the first node, whether a sibling node of the first node exists, and a node corresponding to the sibling node where the sibling node exists may be included in the first pie chart graphic 410.

For example, the parent node of the first node may be expressed using a ring 411 that is a graphic area surrounding the disk constituted by the pie sectors 412, 413, and 414 corresponding to the child nodes of the first node. The ring 411 may be distinguished from the pie sectors 412, 413, and 414 corresponding to the child nodes of the first node using a different color, a pattern, and the like.

The sibling nodes of the first node may be expressed using ovals 415, 416, and 417 that are located outside the disk constituted by the pie sectors 412, 413, and 414 corresponding to the child nodes of the first node. The ovals 415, 416, and 417 may be distinguished from the pie sectors 412, 413, and 414 corresponding to the child nodes of the first node using a different color, a pattern, and the like.

The first pie chart graphic 410 may express the weights of the child nodes included in the first node data using a pie chart, and may also include information associated with the parent node of the first node and the sibling nodes of the first node.

The context information may be expressed as a map 420 that is separated from the first pie chart graphic 410.

The map 420 may be expressed so that the entire hierarchical data structure including the first node may be recognized at a glance. The map 420 may include a plurality of blocks corresponding to the plurality of nodes included in the hierarchical data, respectively.

Each of the blocks included in the map 420 may correspond to a child node of a node of a lower block supporting a corresponding block and may also correspond to a parent node of a node of an upper block supported by the corresponding block.

For example, the first node of the first pie chart graphic 410 may correspond to a block 430.

Among the child nodes of the first node, the child node allocated with the pie sector 412 may correspond to a block 422. The child node allocated with the pie sector 413 may correspond to a block 423, and the child node allocated with the pie sector 414 may correspond to a block 424.

The parent node of the first node expressed using the ring 411 may correspond to a block 421.

Accordingly, a location of each of the nodes including the first node, expressed by the first pie chart graphic 410, within the hierarchical data structure may be recognized on the map 420. The map 420 may provide the context information.

Hereinafter, the context information of the first node verified from the map 420 will be further described.

Referring to the map 420, the block 430 corresponding to the first node expressed using the first pie chart graphic 410 may be provided on the block 421 that is a base block. Accordingly, a tree depth of the first node is “1”. It may be known that the parent node of the first node corresponds to a root node of the entire hierarchical data.

Since three blocks 422, 423, and 424 are provided on the block 430, it may be verified that the first node includes three child nodes. A relative size of each of the child nodes may be in proportion to a weight of each of the child nodes.

Similarly, neighboring blocks 425, 426, and 427 of the block 430 may correspond to sibling nodes of the first node that have the same parent node as the parent node of the first node. Accordingly, it may be verified that the first node includes three sibling nodes. The three sibling nodes may be expressed using the ovals 415, 416, and 417 within the first pie chart graphic 410.

Where a touch input is detected on the input unit 140 of a touch panel type, the processor 130 analyzes the touch input. Where the display unit 110 is a touch screen, the touch input is detected on the display unit 110.

In addition to the input unit 140 of the touch panel type, various types of pointing input devices, for example a mouse, may be used for the input unit 140.

It may be determined whether the touch input corresponds to a drag. The drag may indicate a case where a maximum distance between consecutively touched pixels is greater than or equal to a predetermined threshold.

Where the touch input corresponds to the drag, a direction of the drag may be determined. For example, the drag direction may be determined as left-direction drag or right-direction drag. However, this is only one example, and thus the drag direction may be determined using a type, a structure, a characteristic, or an application example of the hierarchical data.

Where the touch input is determined as a right-direction drag, the processor 130 may determine a sibling node corresponding to the block 425 among the sibling nodes of the first node included in the hierarchical data as a second node that is expressed using the oval 415 and is an access target.

Where the touch input is determined as the left-direction drag, the processor 130 may determine the sibling node, that is expressed using the oval 417 and corresponds to the block 427, as the second node that is an access target.

Where the touch input does not correspond to the drag, a touch input point may be determined. For example, an average location point of a plurality of points touched within a predetermined time interval may be determined as the touch input point.

Where the touch input is determined as a point touch within the pie sector 412, the processor 130 may determine the child node, that is expressed using the pie sector 412 and corresponds to the block 422, as the second node that is the access target.

Where the touch input is determined as a point touch within the pie sector 413, the processor 130 may determine the child node, that is expressed using the pie sector 413 and corresponds to the block 423, as the second node.

Where the touch input is determined as a point touch within the pie sector 414, the processor 130 may determine the child node, that is expressed using the pie sector 414 and corresponds to the block 424, as the second node.

Where the touch input is determined as a point touch within the ring 411, or where the touch point is determined as a point touch on a predetermined portion outside the ring 411 depending on embodiments, the processor 130 may determine the parent node, that is expressed using the ring 411 and corresponds to the block 421, as the second node.

Where the second node is determined, the processor 130 generates a second pie chart for focusing and context expression with respect to the second node in a similar way as generating the first pie chart graphic 410 and the map 420 for focusing and context expression with respect to the first node. The display unit 110 displays the second pie chart. A process of reading, by the processor 130, second node data of the second node from the database 120 to generate the second pie chart may be the same as the aforementioned example of the first node.

In the case of determining the second node that is the access target, where a pointing input, for example, a touch input with respect to a particular block, for example, the blocks 421, 422, 423, 424, 425, 426, and 427 excluding the block 430 corresponding to the first node is received, the processor 130 may determine the particular block as the second node.

According to the above scheme, a user may verify entire context information and directly access a desired block to generate a new pie chart graphic. Accordingly, it may be possible to enhance a user convenience.

The second node that is the access target may be determined through a direct pointing input into a portion of displaying context information according to the above scheme.

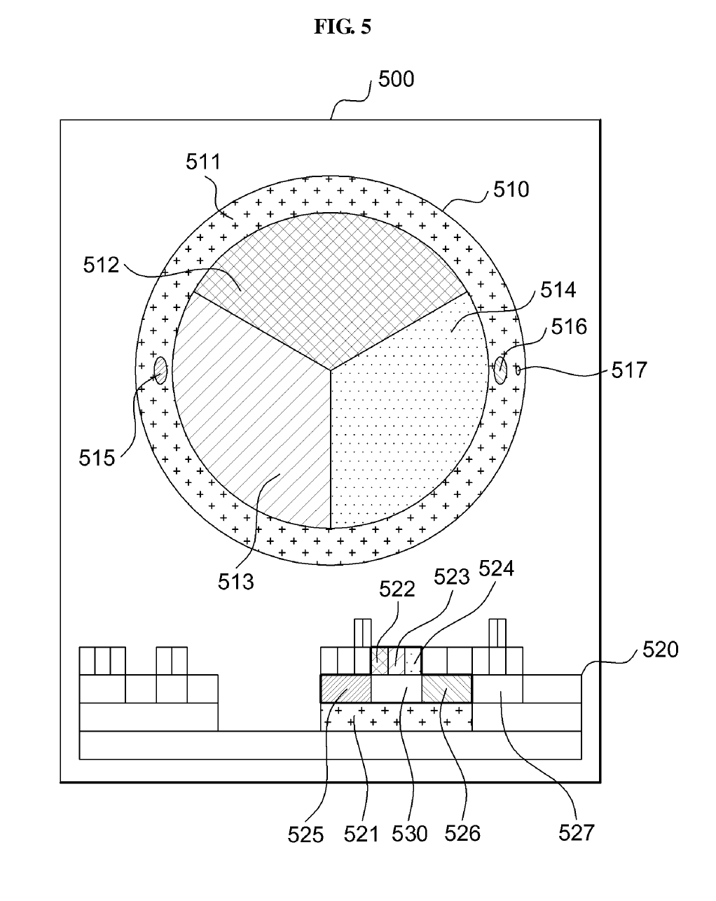

FIG. 5 illustrates a second example of a pie chart graphic 510 that is generated where a touch input is determined as a point touch within the pie sector 413 of FIG. 4.

As shown in the map 420 in FIG. 4, the child node of the first node allocated with the pie sector 413 includes three grandchild nodes of the first node. In a map 520, the three grandchild nodes may be expressed using pie sectors 512, 513, and 514 according to relative sizes of weights of the grandchild nodes. In FIG. 5, the weights of the three grandchild nodes may be nearly the same.

The grandchild nodes may correspond to blocks 522, 523, and 524 of the map 520, respectively.

The second node may correspond to a block 530. The first node that is a parent node of the second node may correspond to a block 521. The first node may be expressed using a ring 511 within the second pie chart graphic 510.

Sibling nodes having the same parent node as of the second node may correspond to blocks 525 and 526. The sibling nodes may correspond to ovals 515 and 516 within the second pie chart graphic 510. Although having a different parent node from the parent node of the second node, a single node having the same tree depth as the second node may be expressed using an oval 517, and correspond to a block 527.

The second pie chart graphic 510 and the map 520 that are displayed on the display unit 110 using an image 500 may perform focusing and provide context information with respect to the second node.

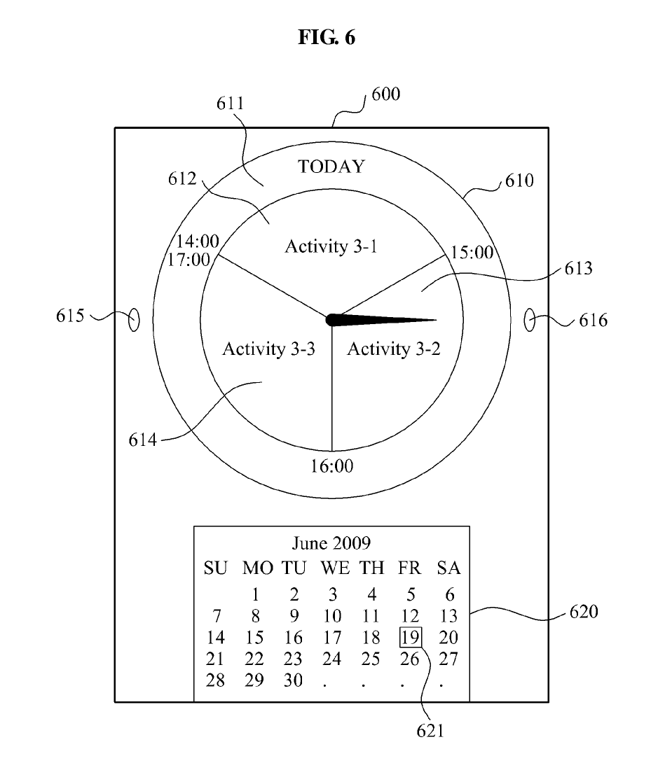

FIG. 6 illustrates an example of a pie chart graphic used as a schedule program.

Hierarchical data may correspond to schedule data used for a personal schedule manager program.

In this example, a displayed image 600 includes a first pie chart graphic 610 focusing first node data corresponding to a particular time zone, and a calendar 620 to enable a user to verify an entire schedule, for example, verifying context.

The hierarchical data may have a hierarchical structure of a year 2009 node-month June node-day 19 node-afternoon time zone node. A day of the week or other information may be included in the hierarchical structure.

The first node that is a current focusing target may be a Jun. 19, 2009 afternoon time zone node.

The first node may include, as child nodes using pie sectors 612, 613, and 614, an activity 3-1 node, an activity 3-2 node, and an activity 3-3 node. Each of the child nodes may have a predetermined weight. Here, the weight indicates a ratio of a corresponding node in the afternoon time zone.

An indicator indicating a current time within the first pie chart graphic 610 may be displayed. The processor 130 may read current time information from a system and include the read current time information in the first pie chart graphic 610.

Ovals 615 and 616 may correspond to sibling nodes of the first node, for example, an afternoon time zone node and an evening time zone, respectively.

A scheme of analyzing a touch input to determine a second node is described above with reference to FIGS. 4 and 5, and thus further description is omitted here.

In this schedule example, a drag direction may be classified into eight directions including up and down, and left and right, whereby it is possible to easily perform a movement according to a date.

For example, where the current first node corresponds to the Jun. 19, 2009 node, a drag input that is directed in a right-downward direction may be detected and thereby be moved to a Jun. 11, 2009 node. For example, the second target that is an access target may become the Jun. 11, 2009 node.

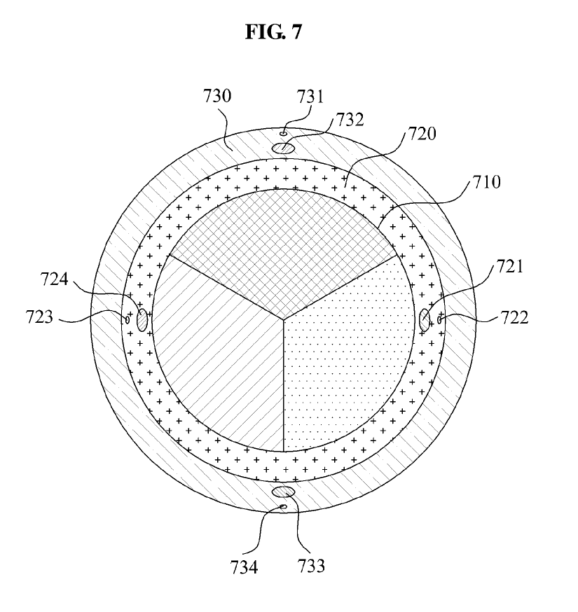

FIG. 7 illustrates an example of a first pie chart graphic 710 illustrated in a data processing apparatus.

A first ring 720 surrounding the first pie chart graphic 710 with respect to a first node, for example, the node 233 of FIG. 2, may correspond to a parent node of the first node 233, for example, the node 230 of FIG. 2. Ovals 721, 722, 723, and 724 are associated with sibling nodes of the first node 233. That is, these nodes have the same parent node as the first node 233 and may be included within the first ring 720.

A second ring 730 surrounding the first ring 720 may correspond to a grandparent node of the first node 233, for example, the node 200 of FIG. 2. Ovals 731, 732, 733, and 734 associated with the child nodes 211, 212, 213, 221, 222, 241, 242, and 243 of the sibling nodes 210, 220, and 240 of the parent node 230 of the first node 233, that is, nodes having the same grandparent node as the first node 233 may be included within the second ring 730.

When a drag input starting from a point within the first ring 720 is detected while the first node 233 is displayed on the first pie chart 710, the processor 130 may determine any one of the sibling nodes 231 and 232 of the first node 233 to be a second node that is an access target. In this example, a drag direction may be used to determine the second node.

Where the drag input starting from a point within the second ring 730 is detected while the first node 233 is displayed on the first pie chart 710, the processor 130 may determine any one of the child nodes 211, 212, and 213, 221 and 222, or 241, 242, and 243 of the sibling nodes 210, 220, or 240 of the parent node 230 of the first node 233 to be the second node. In this example, the drag direction may be used to determine the second node.

It may be assumed that the first node 233 is a node having an index 3 among the child nodes 231, 232, and 233 of the parent node 230. In this example, the node 243 having the same index 3 among the child nodes 241, 242, and 243 of the node 240 adjacent to the parent node 230 of the first node 233 may be determined as the second node according to the drag direction. Where the node having the same index 3 does not exist in a situation where any one of the child nodes 221 and 222 of the node 220 adjacent to the parent node 230 of the first node 233 is desired to be determined as the second node according to the drag direction, a node having a predetermined representative index value, for example, the node 221 having an index 1 may be determined as the second node.

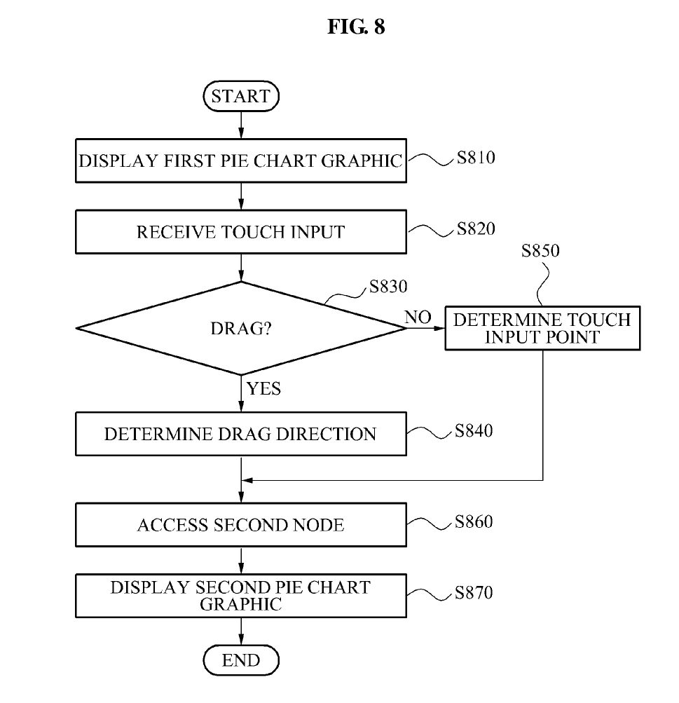

FIG. 8 illustrates an example of a data processing method.

In operation S810, a first pie chart graphic with respect to a first node is displayed. The first node is a current focusing target.

The processor 130 accesses first node data of the first node to read an index and a weight of each of child nodes of the first node.

The processor 130 may divide a disk by allocating a pie sector of a size corresponding to a weight of each of the child nodes of the first node, and thereby generate a pie chart. The display unit 110 displays the pie chart.

Generating/displaying of the first pie chart graphic and displaying of a map for context information are described above with reference to FIG. 4, and thus further description is omitted.

In operation S820, a touch input is received. The processor 130 analyzes the touch input.

In operation S830, it is determined whether the touch input corresponds to a drag. As described above, the drag may be a case where a maximum distance between consecutively touched pixels is greater than or equal to a predetermined threshold.

Where the touch input is determined as the drag, a drag direction of the drag is determined in operation S840. For example, the drag direction may be determined as left or right. It is only an example and thus the drag direction may be determined using a type, a structure, a characteristic, or an application example of hierarchical data.

The processor 130 may determine, as a second node that is an access target, any one of sibling nodes of the first node according to the drag direction. Determining of the second node according to the drag direction is described above with reference to FIG. 4, and thus further description is omitted here.

Conversely, where the touch input does not correspond to the drag, a touch input point is determined in operation S850. For example, an average location point of a plurality of points touched within a predetermined time interval may be determined as the touch input point.

For example, where the touch input point corresponds to a point within the pie sector, the processor 130 may determine, as the second node, a child node that is expressed using the pie sector.

However, where the touch input is determined as a point outside the pie sector, for example, a point outside the ring 411 of FIG. 4 or other portion, the processor 130 may determine a parent node of the first node to be the second node that is an access target.

Where the second node is determined, the second node is accessed in operation S860. A second pie chart graphic is generated using information associated with an index and a weight of each of child nodes of the second node.

Depending on embodiments, to provide context information together with focusing, it may be possible to indicate a parent node of the second node, sibling nodes of the second node, and the like within the second pie chart graphic, and/or to display a map.

In operation S870, the generated second pie chart graphic is displayed.

Depending on embodiments, a third pie chart graphic may be generated and be displayed for focusing third node information while viewing the second pie chart graphic. In this example, after operation S870 is performed, operations S820 through S870 may be repeated.

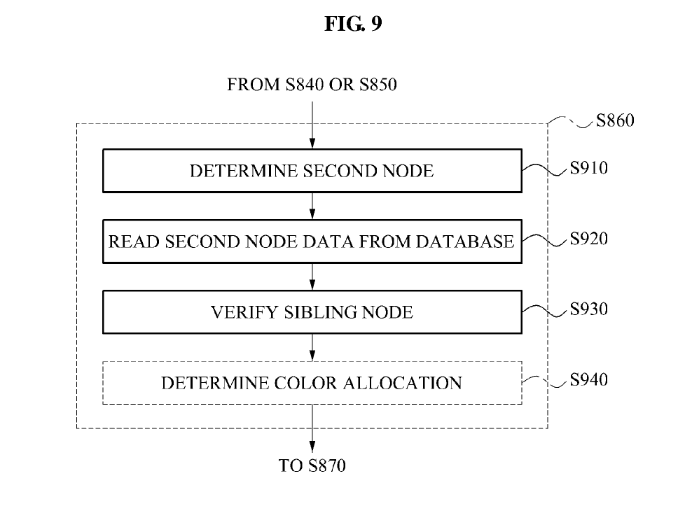

FIG. 9 illustrates an example of a process of accessing the second target that is the access target in operation S860.

In operation S910, the second node that is the access target is determined Where a touch input corresponds to a drag, any one of sibling nodes of the first node may be determined as the second node. Conversely, where the touch input does not correspond to the drag, any one of the parent node and child nodes of the first node may be determined as the second node.

In operation S920, the processor 130 reads second node data of the second node from the database 120. A size of a pie sector to be allocated to each of child nodes of the second node may be calculated using an index and a weight of each of child nodes of the second node.

In operation S930, a node corresponding to a sibling node of the second node is verified by referring to first node data of the first node that is the parent node of the second node.

Depending on embodiments, information associated with the verified sibling node of the second node may be included in the second pie chart graphic together with information associated with the parent node of the second node.

In operation S940, a color allocation and the like within the second pie chart graphic is determined. Pie sectors, a ring, blocks within a map, and the like may be distinguished from each other using a different color, a pattern, and the like.

For example, a color of each of the pie sectors and the blocks may be allocated using a color map of a hue, saturate, value (HSV) color model. Similar colors may be allocated to adjacent blocks. However, where it is difficult to distinguish colors between adjacent blocks, a color different from a corresponding similar color on the color map may be allocated using zittering.

The processes, functions, methods and software described above including a data processing method may be recorded, stored, or fixed in one or more computer-readable media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data processing apparatus, comprising:
a storage unit configured to store hierarchical data;
a display unit configured to display a first pie chart graphic that is generated from first node data of a first node among the hierarchical data; and
a processor configured to:
analyze a pointing input to determine second node data of a second node that is an access target among the hierarchical data; and
generate a second pie chart graphic from the second node data.

2. The apparatus of claim 1, wherein the pointing input corresponds to a touch input.

3. The apparatus of claim 1, wherein the first pie chart graphic comprises at least one of parent node information of the first node and sibling node information of the first node.

4. The apparatus of claim 3, wherein, in response to the display unit displaying the first pie chart graphic, the display unit is further configured to display context information associated with the first node and a node of which information is included in the first pie chart graphic.

5. The apparatus of claim 2, wherein:
in response to the touch input corresponding to a drag, the processor is further configured to analyze a direction of the drag to determine a sibling node of the first node as the second node;
in response to the touch input not corresponding to the drag, the processor is further configured to analyze a touch input point to determine any one of a parent node of the first node and a child node of the first node as the second node; and
the processor is further configured to generate the second pie chart graphic from the determined second node data.

6. The apparatus of claim 1, wherein the second pie chart graphic comprises at least one of parent node information of the second node and sibling node information of the second node.

7. The apparatus of claim 6, wherein the display unit is further configured to convert the first pie chart graphic to the second pie chart graphic generated by the processor to display the converted second pie chart graphic.

8. The apparatus of claim 7, wherein, in response to the display unit displaying the second pie chart graphic, the display unit is further configured to display context information associated with the second node and a node of which information is included in the second pie chart graphic.

9. The apparatus of claim 8, wherein, in response to the pointing input being received in a point corresponding to a third node among the displayed context information, the processor is further configured to:
determine the third node as the second node that is the access target; and
generate the second pie chart graphic from the second node data.

10. The apparatus of claim 1, wherein the hierarchical data corresponds to schedule data used in a personal schedule management program.

11. The apparatus of claim 10, wherein the display unit is further configured to display an indicator indicating a current time together with the first pie chart graphic that is generated from the first node data.

12. The apparatus of claim 10, wherein the display unit is further configured to display context information associated with the first node together with the first pie chart graphic that is generated from the first node data.

13. The apparatus of claim 1, wherein:
the display unit is further configured to display a first graphic area, corresponding to a parent node of the first node, around the first pie chart graphic, and
in response to the pointing input corresponding to a drag input starting from the first graphic area, the processor is further configured to:
determine a sibling node of the first node as the second node that is an access target; and
generate the second pie chart graphic from the second node data.

14. The apparatus of claim 13, wherein:
the display unit is further configured to display a second graphic area, corresponding to a grandparent node of the first node, around the first graphic area, and
in response to the pointing input corresponding to the drag input starting from the second graphic area, the processor is further configured to:
determine any one of child nodes of the sibling node of the grandparent node of the first target as the second node that is the access target; and
generate the second pie chart graphic from the second node data.

15. A data processing method, comprising:
generating a first pie chart graphic from first node data of a first node among hierarchical data to display the first pie chart graphic;
analyzing a touch input detected via a touch panel to determine second node data of a second node that is an access target among the hierarchical data, and to access the second node data; and
generating a second pie chart graphic from the second node data to display the second pie chart graphic.

16. The method of claim 15, wherein the generating and the displaying of the first pie chart graphic comprises:
retrieving a sibling node of the first node by referring to parent node information of the first node;
generating the first pie chart graphic by combining child node information of the first node with at least one of parent node information of the first node and sibling node information of the first node; and
displaying the first pie chart graphic.

17. The method of claim 15, wherein the generating and the displaying of the first pie chart graphic comprises displaying context information associated with the first node and at least one node that is generated into the first pie chart graphic and is displayed together with the first node.

18. The method of claim 16, wherein the analyzing, the determining, and the accessing comprises:
analyzing a drag direction to determine a sibling node of the first node as the second node, where the detected touch input correspond to a drag input;
analyzing a touch input point to determine any one of a parent node of the first node and a child node of the first node as the second node; and
accessing the second node data stored in a database to read the second node data from the database.

19. The method of claim 16, wherein the displaying and the generating of the second pie chart graphic comprises:
retrieving a sibling node of the second node by referring to parent node information of the second node;
generating the second pie chart graphic by combining child node information of the first node with at least one of parent node information of the second node and sibling node information of the second node; and
displaying the second pie chart graphic.

20. A non-transitory computer-readable recording medium storing a program for implementing a data processing method, comprising:
generating a first pie chart graphic from first node data of a first node among hierarchical data to display the first pie chart graphic;
analyzing a touch input detected via a touch panel to determine second node data of a second node that is an access target among the hierarchical data, and to access the second node data; and
generating a second pie chart graphic from the second node data to display the second pie chart graphic.
